(19) United States
(12) Patent Application Publication
(10) Pub. No.: US 2018/0080392 A1
(43) Pub. Date: Mar. 22, 2018

(54) PORTABLE GENERATOR HAVING MULTIPLE FUEL SOURCES

(71) Applicant: Briggs & Stratton Corporation, Wauwatosa, WI (US)

(72) Inventor: Ryan Janscha, Brookfield, WI (US)

(73) Assignee: Briggs & Stratton Corporation, Wauwatosa, WI (US)

(21) Appl. No.: 15/710,122

(22) Filed: Sep. 20, 2017

Related U.S. Application Data
(60) Provisional application No. 62/397,733, filed on Sep. 21, 2016.

(51) Int. Cl. F02D 19/06; F02B 63/04; F02D 41/00

(52) U.S. Cl. CPC F02D 19/0615; F02B 63/048; F02D 19/0647; F02M 21/0287; F02D 19/0681; F02D 19/0623; F02D 41/0027; F02D 19/0665

(57) ABSTRACT

A portable generator includes an engine including an air-fuel mixing device, an alternator, first and second fuel reservoir fluidly coupled to the air-fuel mixing device, a first fuel valve and a second fuel valve movable to an open position that allows fuel to flow from respective fuel reservoirs to the air-fuel mixing device and a closed position that prevents fuel from flowing from respective fuel reservoirs to the air-fuel mixing device, a fuel selector input device operable to select the first or second fuel reservoir as the source of fuel, and a controller programmed to automatically open or close the first fuel valve and open or close the second fuel valve in response to an input from the fuel selector input device indicating selection of the first or second fuel reservoirs.

### CROSS-REFERENCE TO RELATED PATENT APPLICATIONS

This application claims the benefit of U.S. Application No. 62/397,733, filed Sep. 21, 2016, which is incorporated herein by reference in its entirety.

### BACKGROUND

The present invention generally relates to generators. More specifically, the present invention relates to a portable generator having multiple fuel sources.

### SUMMARY

One embodiment of the invention relates to a portable generator including an engine including an air-fuel mixing device, an alternator configured to be driven by the engine to produce electricity, a first fuel reservoir fluidly coupled to the air-fuel mixing device, a second fuel reservoir fluidly coupled to the air-fuel mixing device, a first fuel valve movable to an open position that allows fuel to flow from the first fuel reservoir to the air-fuel mixing device and a closed position that prevents fuel from flowing from the first fuel reservoir to the air-fuel mixing device, a second fuel valve movable to an open position that allows fuel to flow from the second fuel reservoir to the air-fuel mixing device and a closed position that prevents fuel from flowing from the second fuel reservoir to the air-fuel mixing device, a fuel selector input device operable to select the first fuel reservoir or the second fuel reservoir as the source of fuel to the air-fuel mixing device, and a controller programmed to automatically open the first fuel valve and close the second fuel valve in response to an input from the fuel selector input device indicating selection of the first fuel reservoir and automatically close the first fuel valve and open the second fuel valve in response to an input from the fuel selector input device indicating selection of the second fuel reservoir.

Another embodiment of the invention relates to a portable generator including an engine including an air-fuel mixing device, an alternator configured to driven by the engine to produce electricity, a first LPG reservoir, a second LPG reservoir, a manifold fluidly coupled to the first LPG reservoir, the second LPG reservoir, and the air-fuel mixing device so that the LPG supplied to the air-fuel mixing device is drawn simultaneously from both the first LPG reservoir and the second LPG reservoir.

Another embodiment of the invention relates to a portable generator including an engine including an air-fuel mixing device, an alternator configured to be driven by the engine to produce electricity, a first fuel reservoir fluidly coupled to the air-fuel mixing device, a second fuel reservoir fluidly coupled to the air-fuel mixing device, a first fuel valve movable to an open position that allows fuel to flow from the first fuel reservoir to the air-fuel mixing device and a closed position that prevents fuel from flowing from the first fuel reservoir to the air-fuel mixing device, a second fuel valve movable to an open position that allows fuel to flow from the second fuel reservoir to the air-fuel mixing device and a closed position that prevents fuel from flowing from the second fuel reservoir to the air-fuel mixing device, a sensor including at least one of an ambient air temperature sensor, a fuel temperature sensor, a load sensor, a voltage sensor, and a frequency sensor; and a controller programmed to automatically close and open one of the first fuel valve and the second fuel valve in response to an input from the sensor.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1 is a schematic diagram of a dual fuel generator, according to an exemplary embodiment of the invention;

FIG. 2 is a perspective view of a dual fuel generator, according to an exemplary embodiment of the invention; and

FIG. 3 is a perspective view of the dual fuel generator of FIGS. 1 and 2, with multiple liquefied petroleum gas tanks, according to an exemplary embodiment of the invention.

FIG. 4 is a graph of output voltage versus generator runtime in an instance where a gasoline fuel supply was cut off.

FIG. 5 is a graph of output voltage versus generator runtime in an instance where a gasoline fuel supply was cut off.

FIG. 6 is a graph of output voltage versus generator runtime in an instance where an LPG fuel supply was cut off.

FIG. 7 is a graph of output voltage versus generator runtime in an instance where an LPG fuel supply was cut off.

FIG. 8 is a graph of output voltage versus generator runtime in an instance when the generator experiences high loads not due to fuel exhaustion.

FIG. 9 is a graph of output voltage versus generator runtime in an instance where the generator experiences high loads not due to fuel exhaustion.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

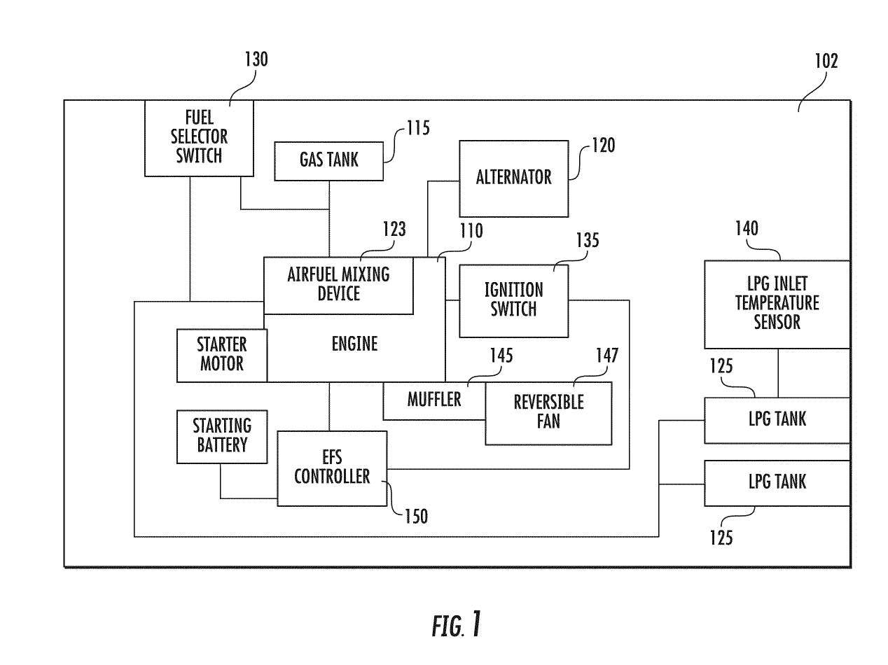

Referring to FIG. 1, a generator 102 is shown according to an exemplary embodiment. The generator 102 includes an engine 110 equipped to run on multiple fuel sources. In a preferred embodiment, the engine 110 can run on either gasoline or liquefied petroleum gas (LPG). In other embodiments, the generator 102 can use other fuel sources or energy sources (e.g., battery power). The generator 102 may selectively operate on gasoline or LPG as desired and controlled by a user, as well as automatically switch between fuel sources during operation. Conventional dual fuel generators do not include the ability to automatically switch between fuel sources during operation but instead require manual switching performed by a user. When using a conventional dual fuel generator, the user is typically required to complete a multi-step manual process of fuel valve manipulation to switch fuel sources.

Automatic fuel source switch-over may be beneficial when LPG from an LPG tank is not available for various reasons. When LPG is not available for use, the system automatically switches to using gasoline. For example, the LPG tanks may become cold during times of relatively cold ambient temperatures. In cases of cold ambient temperatures, it may not be feasible to cold-start the engine using LPG and a different fuel source (e.g., gasoline) may need to be used. As such, automatic selection of gasoline during cold ambient temperatures would be beneficial. Furthermore, both cold ambient temperatures and running the LPG tank at a high-fuel draw under high engine loads (the rate of LPG transfer out of the tank causes the temperature of the tank to drop) can result in a low LPG vaporization rate. Under these conditions, the LPG may fail to vaporize at a sufficient rate for fuel consumption needed to meet the high engine load. Without sufficient fuel provided to the engine, the generator will shut down. Thus, at a predetermined point in time before the LPG temperatures are such that the LPG vaporization rate would be insufficient to keep up with the engine load to run the generator, the system may automatically switch to gasoline as the fuel source for the engine. The system can also automatically switch back to using LPG at a future point in time when the engine load has reduced or LPG temperatures have increased sufficiently to provide the needed LPG vaporization rate to run the generator.

In another example, automatic fuel source switch-over may also be beneficial when the LPG tank has run out of fuel, providing more generator run time for the user without having to manually manipulate the fuel valves of the generator.

In a further example, automatic fuel source switch-over may additionally be beneficial when the gasoline tank has run out of fuel. At a predetermined point in time before the gasoline supply runs out, the system may automatically switch to LPG as the fuel source for the engine, providing more generator run time for the user without having to manually manipulate the fuel valves of the generator.

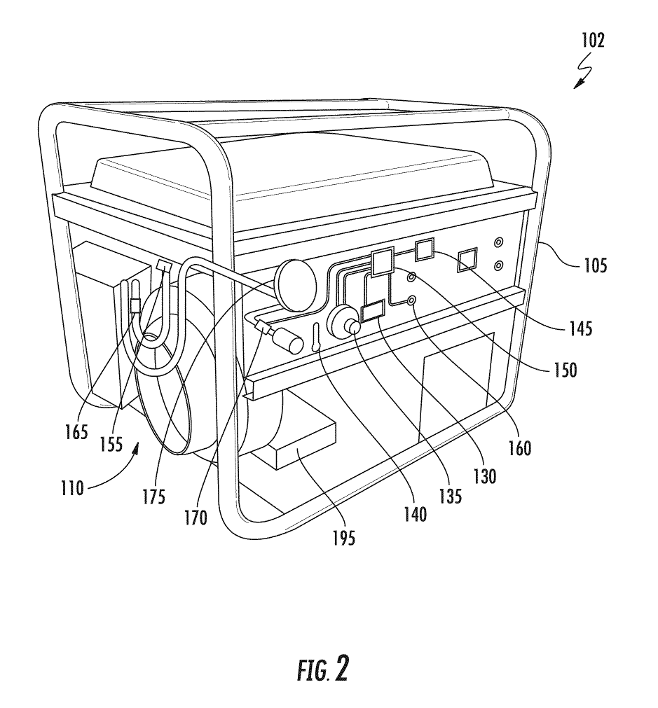

Referring to FIGS. 1-3, the generator 102 includes an engine 110, an alternator 120, a starting battery 113, a starter motor 111, a gasoline tank 115, and one or more LPG tanks 125. The engine 110 further includes an engine block having at least one cylinder, a cylinder head, piston, and crankshaft. The piston reciprocates in a cylinder along a cylinder axis to drive the crankshaft. The engine 110 includes an air-fuel mixing device 123 (e.g., a carburetor, an electronic fuel injection system, a fuel direct injection system, etc.) for supplying an air-fuel mixture to the cylinder and a muffler 145 through which exhaust gases are discharged from the engine 110. The alternator 120 produces electrical power from input mechanical power from the engine 110. The starting battery 111 applies power to the controller 150 described further herein to allow for fuel selection when engine 110 is not started.

As noted above, the generator 102 includes a gasoline tank 115 and one or more LPG tanks 125. The gasoline tank 115 is structured to provide gasoline as fuel for the engine 110. A gasoline valve 165 (e.g., a solenoid valve) selectively allows and disallows the flow of gasoline from the gasoline tank 115 to the air/fuel mixing device 123. The gasoline valve 165 may be positioned in the gasoline fuel line between the gasoline tank 115 and the air/fuel mixing device 123. In another embodiment, the gasoline valve 165 may be positioned in the air/fuel mixing device 123. The gasoline valve 165 can be manually controlled by the user using the fuel selector switch 130 and is additionally automatically and electrically controlled by the controller 150 in the switch-over between LPG and gasoline, as described further herein.

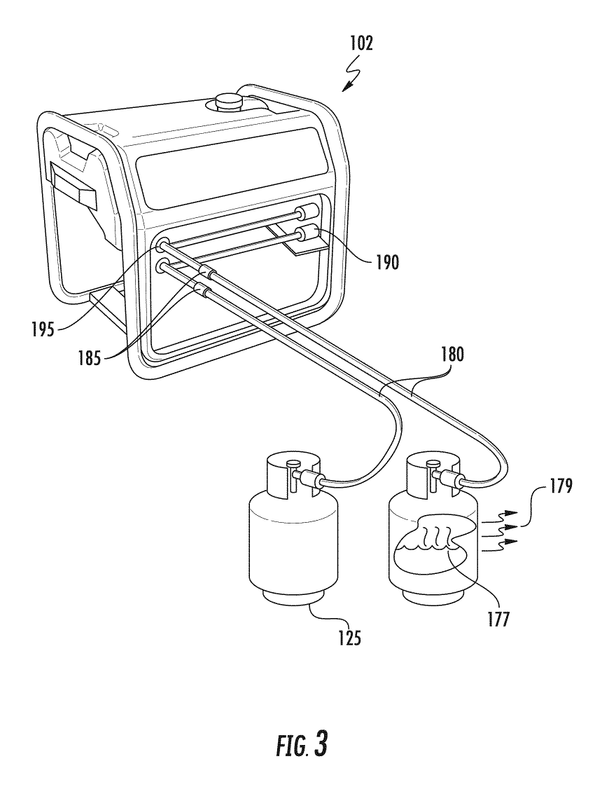

The LPG tanks 125 provide LPG to the engine as fuel. In an exemplary embodiment, the generator 102 includes two LPG tanks 125. In other embodiments, the generator 102 may include more or less LPG tanks. Fuel from the two LPG tanks 125 is simultaneously drawn in parallel with one another so that fuel is supplied simultaneously from both tanks to the air/fuel mixing device 123. Allowing for simultaneous parallel draw of the LPG tanks 125, the fuel draw rate of each tank 125 is reduced, mitigating rapid tank heat loss (shown in FIG. 3 as 177) and lessening the likelihood of fuel starvation due to insufficient LPG vaporization (shown in FIG. 3 as 179). Drawing from both tanks 125 simultaneously reduces the rate of fuel draw from each tank, reducing the cooling of each tank due to rapid fuel draw. The cooling of LPG due to rapid fuel draw can reduce the rate of LPG vaporization which may lead to insufficient fuel supply for the fuel usage rate of the generator 102.

An LPG valve 170 (e.g., a solenoid valve) selectively allows and disallows the flow of LPG from the LPG tank 125 to the air/fuel mixing device 123. The LPG valve 170 may be a single valve after fuel flowing from both tanks 125 are combined or may be two valves, one for each tank 125. The LPG valve 170 can be manually controlled by the user using the fuel selector switch 130 and is additionally automatically controlled by the controller 150 in the switch-over between LPG and gasoline, as described further below.

Fuel valves may include manual shut-offs 155 (e.g., a lever or actuator for user to manipulate).

The generator 102 also includes an ignition switch 135 and a fuel selector switch 130. The ignition switch 135 is provided on the user interface 105 to allow the user to start the generator 102. According to an exemplary embodiment, the ignition switch 135 is a push button. In other embodiments, the ignition switch may also be another device, such as a key switch, etc. During periods of automatic shutdown (e.g., due to fuel starvation, overload, etc.) of the generator 102, the primary ignition is interrupted. After an automatic shutdown, the generator 102 can be restarted by turning the unit off and back on again using the ignition switch 135.

The fuel selector switch 130 is also provided on the user interface 105 to allow the user to switch between fuel options (e.g., LPG, gasoline). The fuel selector switch 130 can be any form of switch, including but not limited to, a push button, toggle switch, rotary switch, etc. The fuel selector switch 130 is communicably and operatively coupled to an electronic fuel selector (EFS) controller 150, as is described further herein, to manage a user-prompted manual change-over between a gasoline and an LPG fuel source option.

The EFS controller 150 controls the operations necessary to switch between the two fuel sources—LPG and gasoline. The controller 150 may also control other operations of the generator 102. The controller 150 may include various circuits and controls to operate the fuel valves (e.g., gasoline valve 165, LPG valve 170) for each of the gasoline tank 115 and LPG tanks 125. The controller 150 receives inputs from the fuel selector switch 130 and sends control signals to electro-mechanically open and close the fuel valves in the generator 102 to effectuate fuel selection. Accordingly, the controller 150 is communicably and operatively coupled to the fuel selector switch 130 to control the operations of the generator 102.

The controller 150 is additionally configured to automatically control the fuel valves (e.g., LPG valve 170, gasoline valve 165) of the generator 102 for automatic fuel source switch-over. Automatic switch-over can be triggered in response to an actual lack of available fuel from the current fuel supply and also by an anticipated lack of available fuel from the current fuel supply. Actual lack of fuel can be directly detected by a fuel level sensor, for example, a weight sensor to detect available fuel in an LPG tank 125 as a function of change in weight. As another example, a liquid level sensor can be used to detect the amount of gasoline in the gasoline tank 115. Anticipated lack of fuel from the LPG tanks can be determined based on temperature to detect situations in which the rate of LPG vaporization is not sufficient to keep up with the engine load. The anticipated lack of fuel from the LPG tanks can also be determined based on changes in the alternator 120 output (e.g., voltage, frequency) over time that is indicative of a lack of fuel sufficient to keep up with the engine load.

The controller 150 receives temperature data from an LPG inlet temperature sensor 140 to determine automatic fuel source switch-over. The LPG inlet temperature sensor 140 senses the temperature of the in-flowing LPG proximate the LPG inlet 195 of the generator 102. The LPG inlet temperature can be used to determine if a fuel source switch-over is necessary. For example, if the LPG inlet temperature shows that the in-flowing LPG is below a predetermined temperature, the controller 150 closes the LPG valve 170 and opens the gasoline valve 165 to switch the flow of fuel from the LPG tanks 125 to the gasoline tank 115. Similarly, if the LPG inlet temperature sensor 140 senses that the LPG temperature is above a predetermined temperature, the controller 150 can close the gasoline valve 165 and open the LPG valve 170 to allow LPG to flow into the engine 110 as the fuel source.

In a similar manner, the controller 150 controls which fuel source is used for starting the engine 110. The controller 150 may be communicably coupled to an ambient temperature sensor to sense the ambient temperature. During cold ambient temperatures, it may be necessary to start the engine 110 using gasoline. During relatively warmer ambient temperatures, the engine 110 may be started using LPG. Thus, in one embodiment, if the ambient temperature is above a certain threshold value, the controller 150 closes the gasoline valve 165 and opens the LPG valve 170 to allow flow of LPG into the air/fuel mixing device 123. Further, if the ambient temperature is below the threshold value, the controller 150 closes the LPG valve 170 and opens the gasoline valve 165 to allow flow of gasoline into the air-fuel mixing device 123 to start the engine 110. In this case, the controller 150 can monitor the temperature of the LPG and switch to LPG fuel (e.g., by closing the gasoline valve 165 and opening the LPG valve 170) once the temperature of the LPG has reached a predetermined value. In another embodiment, regardless of the ambient temperature, the controller 150 may always signal for the engine 110 to be started using gasoline.

In some embodiments, the controller 150 also receives sensing information from a fuel level sensor within each tank (e.g., LPG tank 125, gasoline tank 115) to determine fuel levels within each tank. For example, a weight sensor can be positioned within each LPG tank 125 such that the fuel levels of the tanks 125 can be determined. The fuel level within the LPG tanks 125 can be used to determine whether it is necessary to switch the fuel source over to the gasoline tank 115. For example, if the weight sensor communicates that the fuel level is low in the LPG tanks 125, the controller 150 switches the gasoline valve 165 to open and the LPG valve 170 to closed. As another example, a fuel level sensor can be positioned within the gasoline tank 115 such that the fuel level of the gasoline tank 115 can be determined. The fuel level within the gasoline tank 115 can be used to determine whether it is necessary to switch the fuel source over to the LPG tanks 125. For example, if the fuel level sensor communicates that the fuel level is low in the gasoline tank 115, the controller 150 switches the LPG valve 170 to open and the gasoline valve 165 to closed.

The controller 150 is additionally configured to sense a load on the engine 110 and determine the fuel source using sensed load values. The controller 150 may receive position values from a throttle of the engine 110 to determine the load value. In other embodiments, the controller 150 may use alternator outputs to determine load values on the engine 110. For example, output voltage values can be used to determine load on the engine 110 (as noted in the attached Appendix). If while using LPG as a fuel source, a predetermined load value is exceeded, the controller 150 will close the LPG valve 170 and open the gasoline valve 165 to switch the fuel source to gasoline. Threshold voltage or frequency change exceeding the threshold time change is an indication of anticipated lack of fuel. The engine 110 may still be running so that there is not a total lack of fuel, but fuel starvation is imminent. The change in alternator output due to individual high load events (e.g., providing start-up power to an air conditioning unit) falls within the threshold voltage or frequency change and the threshold time change such that a switch-over is not triggered by the events.

In some embodiments, the controller 150 is further configured to control operation of a reversible fan 147 to heat and/or cool the LPG tanks 125. In an alternative embodiment, the LPG tanks 125 can be heated and/or cooled using electrically resistive heating or thermo-electric cooling methods. The controller 150 can use inlet LPG temperatures received from the LPG inlet temperature sensor 140 to determine whether to heat or cool the LPG tanks 125 using the reversible fan 147. For example, if the LPG inlet temperature is below a certain threshold, the controller 150 may operate the reversible fan in a direction to direct waste heat from the muffler 145 or elsewhere from the engine 110 and/or generator 102 over the LPG tanks 125 to heat the tanks. If the LPG inlet temperature is above a certain threshold, the controller 150 may operate the reversible fan in an opposite direction to direct cooling air over the LPG tanks 125 to cool the tanks.

The reversible fan 147 is an electric fan configured to blow hot waste air over the LPG tanks 125 if the LPG temperature sensor 140 senses that the LPG tanks 125 are below a certain predetermined temperature (e.g., 80 degrees Fahrenheit (° F.)) such that freeze-up of the LPG tanks 125 is imminent. The reversible fan 147 is preferably positioned in the flow of exhaust gases from the muffler 145 to utilize the waste heat from the engine 110. The reversible fan 147 is additionally configured to reverse and blow cool air over the LPG tanks 125 if the LPG temperature sensor 140 senses that the LPG tanks 125 are above a certain predetermined temperature.

As shown in FIG. 3, the LPG tanks 125 are each separately connected to the generator 102 via a hose 180 at an LPG inlet 195. In other embodiments, the LPG tanks 125 can be connected via other hose arrangements, such as via a quick-connect hose arrangement or a “T” hose connector. Each hose 180 includes a check valve 185 to allow only a one-way flow of fluid from the LPG tanks 125. Beneficially, when only a single LPG tank 125 is connected, having a separate check valve 185 for each LPG tank 125 and hose 180 prevents the possibility of outflow of LPG from the remaining tank 125 to atmosphere.

In a preferred embodiment, the LPG tanks 125 are mounted onto or positioned proximate the generator 102 such that heat from the generator 102 is supplied to the tanks 125 and the likelihood of tank icing (e.g., freeze-up) is reduced. In another embodiment, the LPG tanks 125 can be mounted at or near the flow of exhaust gases from the muffler 145 such that the waste heat from the generator 102 is provided to the LPG tanks 125 using a reversible fan 147. In a further embodiment, the LPG tanks 125 are positioned elsewhere relative to (e.g., remote from) the generator 102. When LPG tanks 125 are not connected to the generator 102, each hose 180 can be retained (e.g., stored) on the generator either with or without caps, shown in FIG. 3 as stored position 190.

At LPG regulator 175 (e.g., stage 1 regulator) is included along the LPG fuel line preferably between the LPG valve 170 and the air-fuel mixing device 123. In alternative embodiments, the LPG regulator 175 can be positioned at any point along the fuel line between the LPG inlet 195 on the generator 102 and the air/fuel mixing device 123. The LPG regulator 175 regulates the pressure of the LPG flowing into the generator. In a preferred embodiment, a second LPG regulator (e.g., stage 2 regulator) is included and regulates the pressure of the LPG flow to a pressure appropriate for fuel supplied to the air/fuel mixing device 123. In other embodiments, more or less LPG regulators are utilized.

In another embodiment, the generator 102 includes a power supply (e.g., one or more batteries, capacitors, etc.) as an alternative energy source to provide power from the generator 102. Either the alternator or the power supply can provide electricity to one or more electrical outlets that enable the user to power a load. The power supply includes a power switch movable between an open position preventing electricity flow from the power supply to the electrical outlet and a closed position allowing electricity flow from the power supply to the electrical outlet. In an energy switch-over to the power supply, the generator 102 closes the fuel valves (e.g., gasoline valve 165, LPG valve 170) and closes the power switch to switch the power output from the alternator 120 to the power supply to provide output power from the generator 102 via the electrical outlet. The generator 102 may be started using the power supply and may switch to the power supply while running. Upon sensing imminent fuel exhaustion, LPG tank freeze-up, or other issues the generator may commence an energy source switch-over to the power supply. For example, if a fuel level sensor in the gasoline tank 115 indicates imminent fuel exhaustion, the generator 102 will close the gasoline valve 165 to stop the flow of gasoline to the air/fuel mixing device 123 and will close the power switch from the power supply to the engine 110 to provide output power from the power supply via the electrical outlet.

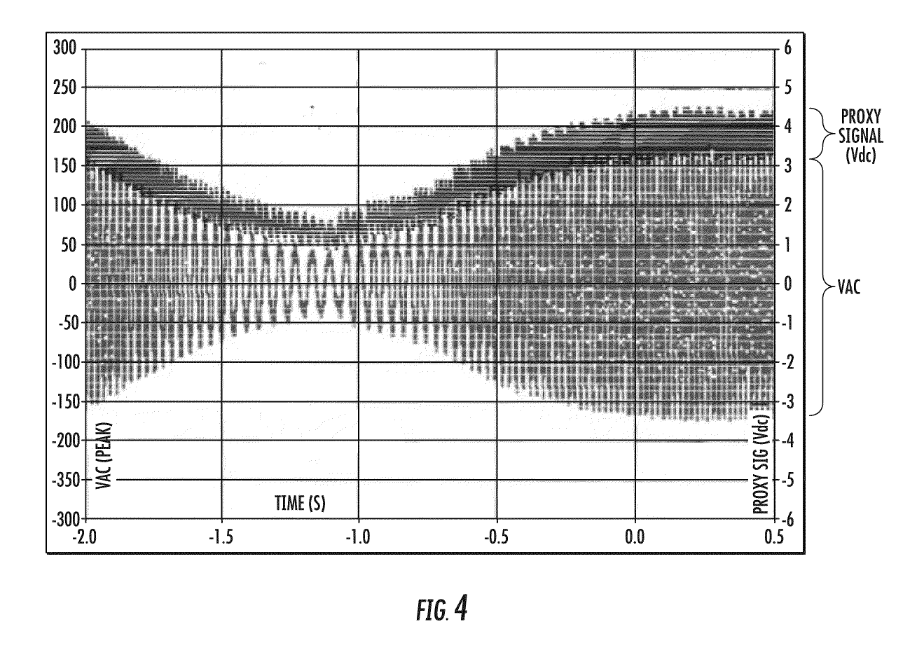

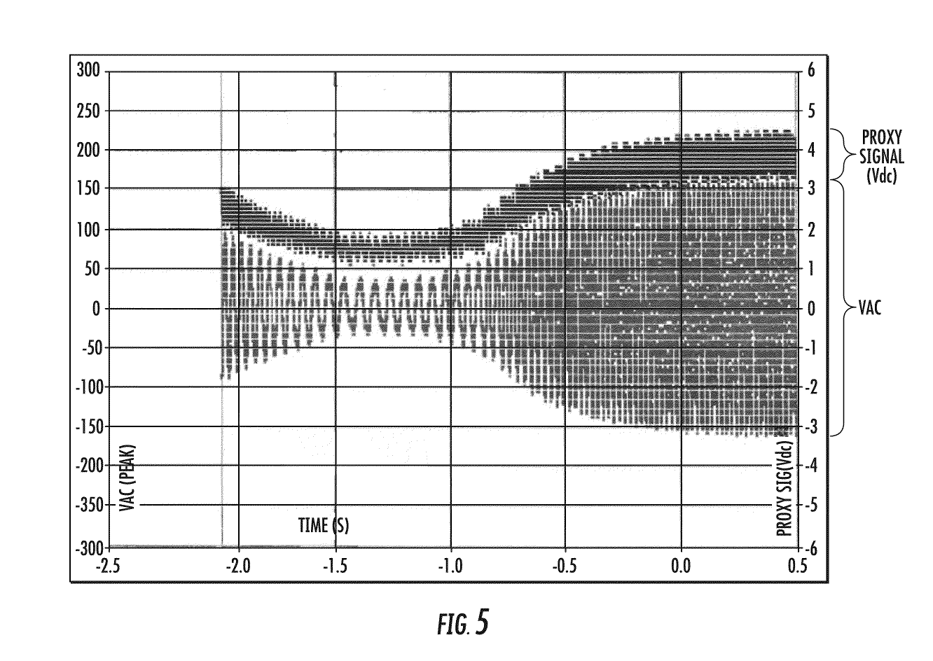

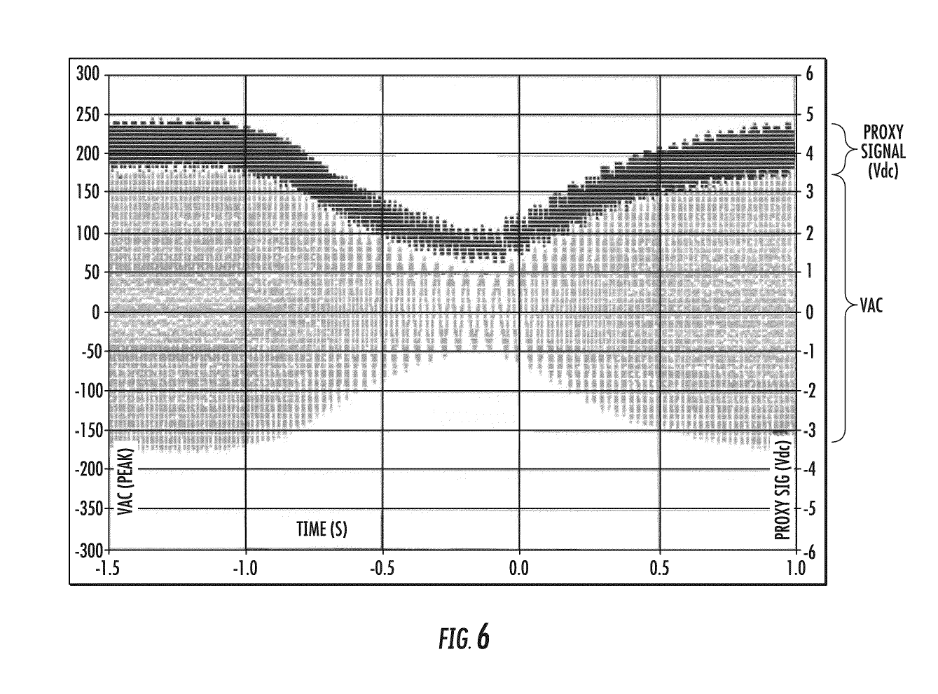

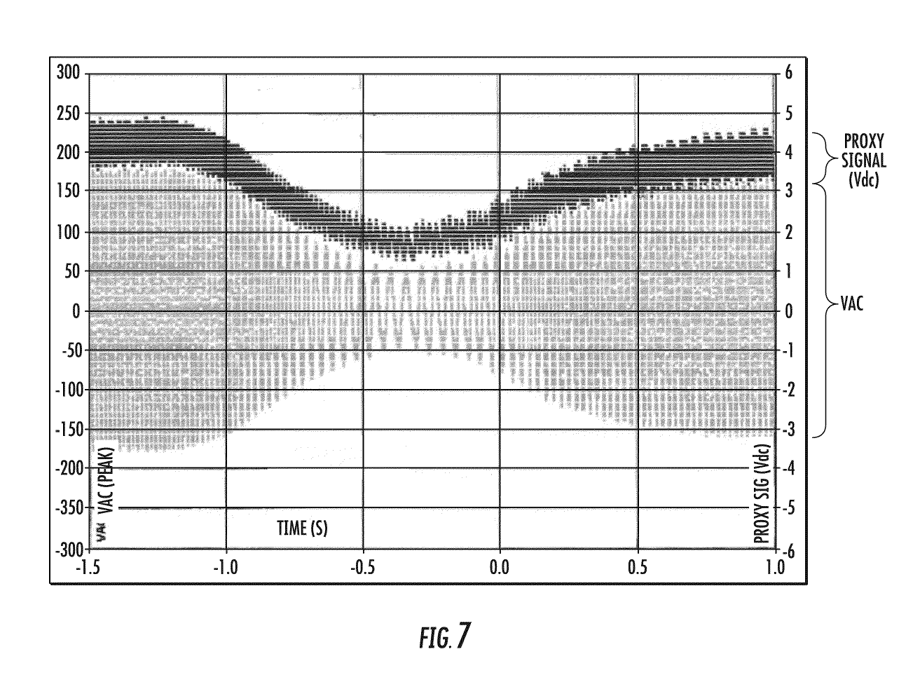

Referring to FIGS. 4-7, graphs showing output voltage versus run time for an instance where a primary fuel supply was cut off (e.g., fuel exhaustion, etc.) are displayed. To determine a point in time for fuel source switch-over, the drop in output voltage versus time is monitored. The graphs shown in FIGS. 4-5 display an instance when the gasoline fuel supply was cut off, leading to a temporary drop in output voltage until the system switched to a secondary fuel supply (e.g., LPG). As shown in the graphs in FIGS. 6-7, the LPG fuel supply was cut off, leading to a temporary drop in output voltage until the system switched to the gasoline fuel supply.

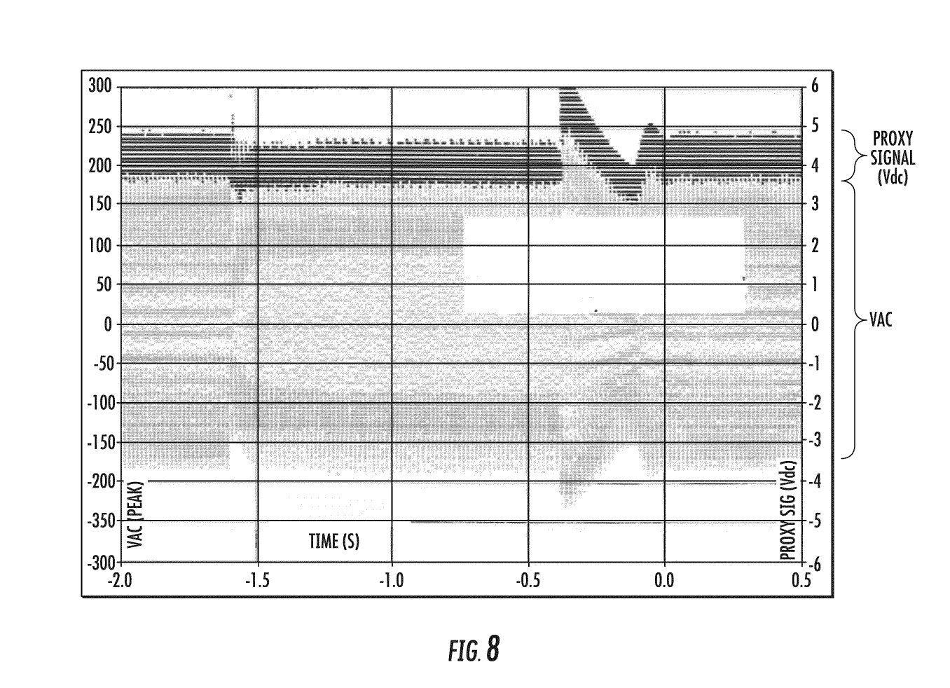

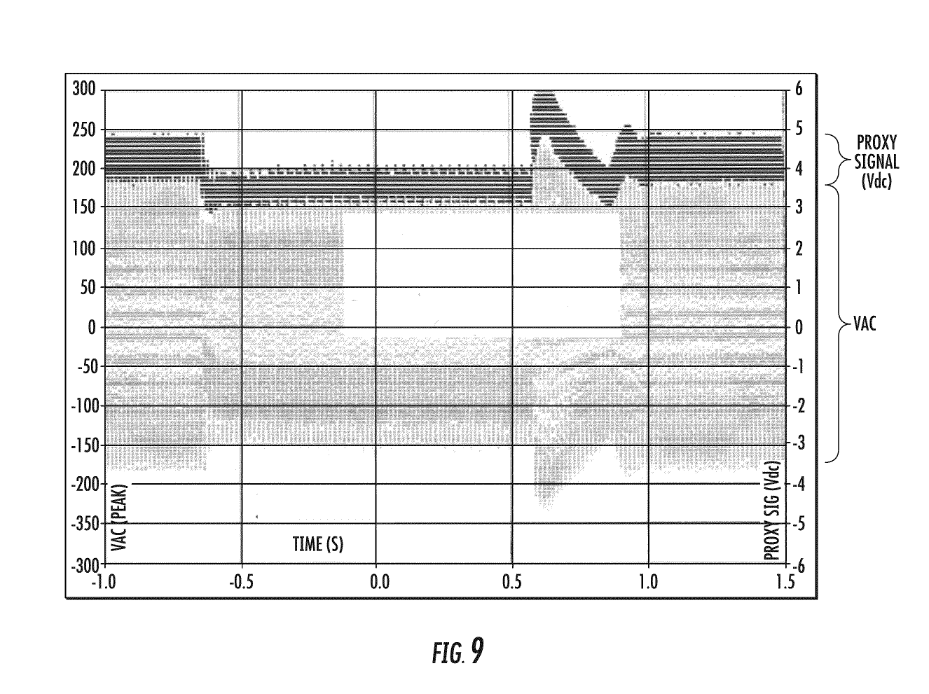

It is important to note that although there are sensed drops in output voltage shown in FIGS. 4-7, the fuel switch-over will not be inadvertently invoked due to a high-starting load (e.g., due to starting an air conditioner as seen in this example) or generator overload conditions. As shown in FIGS. 8-9, a different voltage signal is generated when high loads are experienced that are not due to fuel exhaustion. FIGS. 8-9 show that although the generator experienced high loads and a resulting temporary voltage drop, the system did not activate a fuel switch-over. The output change threshold (e.g., voltage, frequency) and the time change threshold are determined so that inadvertent switch-over does not occur.

As noted above, typical dual fuel generators require manual manipulation of fuel valves by the user to switch fuel sources. Conventional dual fuel generators do not allow for automatic switch-over of fuel sources during operation. If a user desires to switch fuel sources, the user must first stop the unit and take multiple steps to change the fuel source, including, but not limited to, connecting and disconnecting hoses, setting the appropriate fuel valve, and moving or sliding a selector knob to select the appropriate fuel source. In many cases of conventional dual fuel generators, the selector knobs will not move without first proper manual setting of the fuel valves by the user. Furthermore, typical dual fuel generators do not make use of the waste heat coming from the generator. Thus, LPG fuel exhaustion and tank freeze-up can be a common occurrence. Additionally, conventional dual fuel generators use only a single LPG tank, resulting in rapid fuel draw in situations of high load on the generator producing low LPG vaporization rates. Low LPG vaporization rates can lead to shutdowns of the generator due to insufficient fuel supply to maintain proper loads on the generator.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

What is claimed is:

1. A portable generator, comprising:
an engine including an air-fuel mixing device;
an alternator configured to be driven by the engine to produce electricity;
a first fuel reservoir fluidly coupled to the air-fuel mixing device;
a second fuel reservoir fluidly coupled to the air-fuel mixing device;
a first fuel valve movable to an open position that allows fuel to flow from the first fuel reservoir to the air-fuel mixing device and a closed position that prevents fuel from flowing from the first fuel reservoir to the air-fuel mixing device;
a second fuel valve movable to an open position that allows fuel to flow from the second fuel reservoir to the air-fuel mixing device and a closed position that prevents fuel from flowing from the second fuel reservoir to the air-fuel mixing device;
a fuel selector input device operable to select the first fuel reservoir or the second fuel reservoir as the source of fuel to the air-fuel mixing device; and
a controller programmed to:
automatically open the first fuel valve and close the second fuel valve in response to an input from the fuel selector input device indicating selection of the first fuel reservoir;
automatically close the first fuel valve and open the second fuel valve in response to an input from the fuel selector input device indicating selection of the second fuel reservoir.

2. The generator of claim 1, further comprising:
an ambient air temperature sensor;
wherein the controller is programmed to:
automatically close the first fuel valve and open the second fuel valve in response to an input from the ambient air temperature sensor indicating an ambient air temperature is above a predetermined ambient temperature threshold; and
automatically open the first fuel valve and close the second fuel valve in response to input from the ambient air temperature sensor indicating the ambient air temperature is below the predetermined ambient temperature threshold.

3. The generator of claim 1, further comprising:
a fuel temperature sensor;
wherein the controller is programmed to:
automatically close the first fuel valve and open the second fuel valve in response to input from the fuel temperature sensor indicating a fuel temperature is above a predetermined fuel temperature threshold; and
automatically open the first fuel valve and close the second fuel valve in response to input from the fuel temperature sensor indicating the fuel temperature is below the predetermined fuel temperature threshold.

4. The generator of claim 1, further comprising:
a load sensor;
wherein the controller is programmed to:
automatically open the first fuel valve and close the second fuel valve in response to input from the load sensor indicating an engine load is above a predetermined engine load threshold; and
automatically close the first fuel valve and open the second fuel valve in response to input from the load sensor indicating the engine load is below the predetermined engine load threshold.

5. The generator of claim 1, further comprising:
a voltage sensor configured to detect a voltage indicative of the output voltage of the alternator;
wherein the controller is programmed to:
automatically open the first fuel valve and close the second fuel valve in response to input from the voltage sensor indicating an a voltage change that exceeds a voltage change threshold for a duration greater than a time threshold.

6. The generator of claim 1, further comprising:
a frequency sensor configured to detect a frequency indicative of the output frequency of the alternator;
wherein the controller is programmed to:
automatically open the first fuel valve and close the second fuel valve in response to input from the frequency sensor indicating an a frequency change that exceeds a frequency change threshold for a duration greater than a time threshold.

7. The generator of claim 1, wherein the first fuel reservoir comprises a gasoline reservoir.

8. The generator of claim 7, wherein the second fuel reservoir comprises a plurality of liquefied petroleum gas (LPG) reservoirs.

9. The generator of claim 8, further comprising:
an exhaust muffler;
a reversible fan configured to direct air over the second fuel reservoir in a first direction when rotating in a first fan direction and to direct air over the second fuel reservoir in a second direction when rotating in a second fan direction;
an LPG temperature sensor configured to sense an LPG temperature of the second fuel reservoir;
wherein the controller is programmed to:
automatically rotate the reversible fan in the first fan direction in response to input from the LPG temperature sensor indicating the LPG temperature is below a first predetermined LPG temperature threshold such that waste heat from the exhaust muffler warms the second fuel reservoir; and
automatically rotate the reversible fan in the second fan direction in response to an input from the LPG temperature sensor indicating the LPG temperature is above a second predetermined LPG temperature threshold such that ambient air cools the second fuel reservoir.

10. A portable generator, comprising:
an engine including an air-fuel mixing device;
an alternator configured to driven by the engine to produce electricity;
a first LPG reservoir;
a second LPG reservoir;
a manifold fluidly coupled to the first LPG reservoir, the second LPG reservoir, and the air-fuel mixing device so that the LPG supplied to the air-fuel mixing device is drawn simultaneously from both the first LPG reservoir and the second LPG reservoir.

11. The generator of claim 10, further comprising:
a first hose for connecting the first LPG reservoir to the generator;
a second hose for connecting the second LPG reservoir to the generator;
a first check valve; and
a second check valve;
wherein the first check valve is configured to prevent a flow of LPG from the manifold to atmosphere via the first hose when the first hose is disconnected from the first LPG reservoir;
wherein the second check valve is configured to prevent a flow of LPG from the manifold to atmosphere via the second hose when the second hose is disconnected from the second LPG reservoir.

12. The generator of claim 10, further comprising:
an LPG temperature sensor configured to detect an LPG temperature;
a fan configured to direct air over one of the first and second the LPG reservoirs in a first direction when rotating in a first fan direction; and
a controller programmed to automatically rotate the fan in the first fan direction in response to input from the LPG temperature sensor indicating the LPG temperature is below a first predetermined LPG temperature threshold such that waste heat from the engine warms the first and the second LPG reservoirs.

13. The generator of claim 10, wherein the engine includes an exhaust muffler; and
wherein the fan is positioned near the muffler so that the waste heat is supplied by the exhaust muffler.

14. The generator of claim 10, wherein the fan is configured to direct air over the LPG reservoir in a second direction when rotating in a second fan direction; and
wherein the controller is programmed to automatically rotate the fan in the second fan direction in response to an input from the LPG temperature sensor indicating the LPG temperature is above a second predetermined LPG temperature threshold such that ambient air cools the LPG reservoir.

15. A portable generator, comprising:
an engine including an air-fuel mixing device;
an alternator configured to be driven by the engine to produce electricity;
a first fuel reservoir fluidly coupled to the air-fuel mixing device;
a second fuel reservoir fluidly coupled to the air-fuel mixing device;
a first fuel valve movable to an open position that allows fuel to flow from the first fuel reservoir to the air-fuel mixing device and a closed position that prevents fuel from flowing from the first fuel reservoir to the air-fuel mixing device;
a second fuel valve movable to an open position that allows fuel to flow from the second fuel reservoir to the air-fuel mixing device and a closed position that prevents fuel from flowing from the second fuel reservoir to the air-fuel mixing device;
a sensor comprising at least one of an ambient air temperature sensor, a fuel temperature sensor, a load sensor, a voltage sensor, and a frequency sensor; and a controller programmed to:
automatically close and open one of the first fuel valve and the second fuel valve in response to an input from the sensor.

16. The generator of claim 15, wherein the sensor comprises an ambient air temperature sensor;
wherein the controller is programmed to:
automatically close the first fuel valve and open the second fuel valve in response to an input from the ambient air temperature sensor indicating an ambient air temperature is above a predetermined ambient temperature threshold; and
automatically open the first fuel valve and close the second fuel valve in response to input from the ambient air temperature sensor indicating the ambient air temperature is below the predetermined ambient temperature threshold.

17. The generator of claim 15, wherein the sensor comprises a fuel temperature sensor;
wherein the controller is programmed to:
automatically close the first fuel valve and open the second fuel valve in response to input from the fuel temperature sensor indicating a fuel temperature is above a predetermined fuel temperature threshold; and
automatically open the first fuel valve and close the second fuel valve in response to input from the fuel temperature sensor indicating the fuel temperature is below the predetermined fuel temperature threshold.

18. The generator of claim 15, wherein the sensor comprises a load sensor;
wherein the controller is programmed to:
automatically open the first fuel valve and close the second fuel valve in response to input from the load sensor indicating an engine load is above a predetermined engine load threshold; and
automatically close the first fuel valve and open the second fuel valve in response to input from the load sensor indicating the engine load is below the predetermined engine load threshold.

19. The generator of claim 15, wherein the sensor comprises a voltage sensor configured to detect a voltage indicative of the output voltage of the alternator;
wherein the controller is programmed to automatically open the first fuel valve and close the second fuel valve in response to input from the voltage sensor indicating an a voltage change that exceeds a voltage change threshold for a duration greater than a time threshold.

20. The generator of claim 15, wherein the sensor comprises a frequency sensor configured to detect a frequency indicative of the output frequency of the alternator;
wherein the controller is programmed to automatically open the first fuel valve and close the second fuel valve in response to input from the frequency sensor indicating an a frequency change that exceeds a frequency change threshold for a duration greater than a time threshold.
